(19) United States
(12) Patent Application Publication
(10) Pub. No.: US 2010/0221416 A1
(43) Pub. Date: Sep. 2, 2010

(54) SYSTEM, METHOD AND APPARATUS FOR COMBINING THE PROCESSES OF LUBRICATION AND FINAL TAPE POLISH FOR MAGNETIC MEDIA

(75) Inventors: Xing-Cai Guo, Tracy, CA (US); Thomas Edward Karis, Armoras, CA (US)

Correspondence Address: Larson Newman & Abel, LLP, 5914 West Courtyard Drive, Suite 200, Austin, TX, 78730, US

(73) Assignee: HITACHI GLOBAL STORAGE TECHNOLOGIES NETHERLANDS BV, 1076 AZ Amsterdam (NL)

(21) Appl. No.: 12/394,082

(22) Filed: Feb. 27, 2009

(51) Int. Cl. B05D 5/12

(52) U.S. Cl. 427/127

(57) ABSTRACT

The manufacturing processes of lubrication and final tape polish (FTP) for magnetic media are combined into a single operation. A modified disk loading conveyor performs both lubricant dipping and FTP by immersing a cassette of disks in a lube bath. A single disk is lubed as it is unloaded. Upon unload, the lubed disk is put on an FTP spindle for polishing. After FTP, the disk is put in an empty cassette adjacent the lube bath. An automatic lift transports fill or empty cassettes into or out of the lube bath, respectively.

### BACKGROUND OF THE INVENTION

1. Technical Field

The present invention relates in general to processing media and, in particular, to an improved system, method and apparatus for combining into a single operation the processes of lubrication and final tape polish for magnetic media in hard disk drives.

2. Description of the Related Art

The glide test is one of the operations performed at the end of manufacturing magnetic media for hard disk drives. To maintain or increase media glide yield, the amount of friction encountered during the processing step known as final tape polish (FTP) must be maintained or reduced. The friction is determined by the amount of free (i.e., non-bonded) lubricant present on the media during FTP. Generally, lubricant bonding to media increases with time until an equilibrium bonding is reached. The time required to reach equilibrium bonding varies with lubricant type and other variables, and may comprise anywhere from a few minutes to a few days. During manufacturing, the time delays for transitioning the media from the lubrication process to the FTP proess are kept as short as practically possible. For example, the time delay between these processes may take two to four hours.

To reduce disturbance of the lubricant on the media and to avoid lubricant pickup in disk drives, media manufacturers continue to move toward higher bonding lubricants (e.g., Zdol to Z-Tetraol to ZTMD). However, high bonding lubricants also bond relatively quickly (e.g., within a few minutes). Since separate and independent lubrication and FTP processes are currently required, it is practically impossible to shorten the delay time between these operations from a few hours to only minutes.

Another issue to address in order to increase production volume and/or to implement discrete track media and bit patterned media technologies, is the need for more clean room floor space for these operations. Although one way to solve this problem is to increase the size of the clean room facilities, this is a very expensive proposition. Moreover, some manufacturing sites have almost no room for expansion. Thus, an improved solution for addressing the lubricant and FTP requirements for media that addresses all of these issues would be desirable.

### SUMMARY OF THE INVENTION

Embodiments of a system, method, and apparatus for combining into a single operation the processes of lubrication and final tape polish (FTP) for magnetic media are disclosed. The invention uses a single tool to combine lubricant dipping with final tape polish using a modified disk loading conveyor. In one embodiment, a cassette of disks moved into and immersed in a lube bath, and a single disk is lubed as it is unloaded. Upon unload, the lubed disk is transported by a robot arm to the FTP spindle. After FTP, the disk is put in an empty cassette on the conveyor downstream from the lube bath. An automatic lift transports full or empty cassettes into or out of the lube bath with respect to the conveyor.

The invention has the advantages of shortening the lube-to-FTP delay between those processes, which means more free lubricant, lower burnish friction, and a higher yield during the glide test for disk drive applications. The invention also reduces the floor space required for conventional implementations of lubrication and FTP equipment, giving room for expansion in a clean room facility without having to build larger clean rooms. In addition, the invention provides these advantages while maintaining the same throughput, lubricant uniformity, and media quality as conventional techniques.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention are attained and can be understood in more detail, a more particular description of the invention briefly summarized above may be had by reference to the embodiments thereof that are illustrated in the appended drawings. However, the drawings illustrate only some embodiments of the invention and therefore are not to be considered limiting of its scope as the invention may admit to other equally effective embodiments.

FIGS. 1-8 are schematic diagrams of embodiments of processes in accordance with the invention; and

FIGS. 9-14 are plots of performance for media constructed in accordance with the invention.

### DETAILED DESCRIPTION OF THE INVENTION

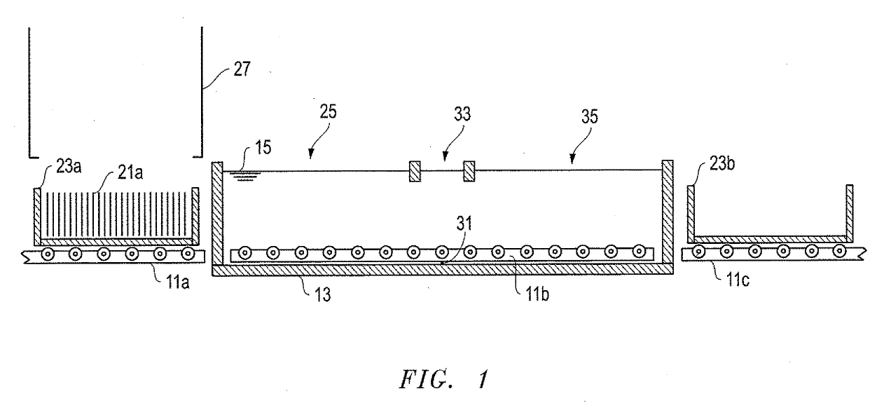

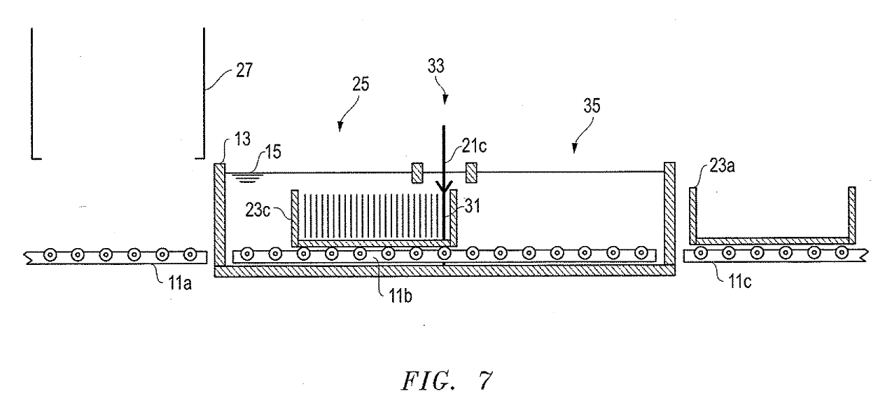

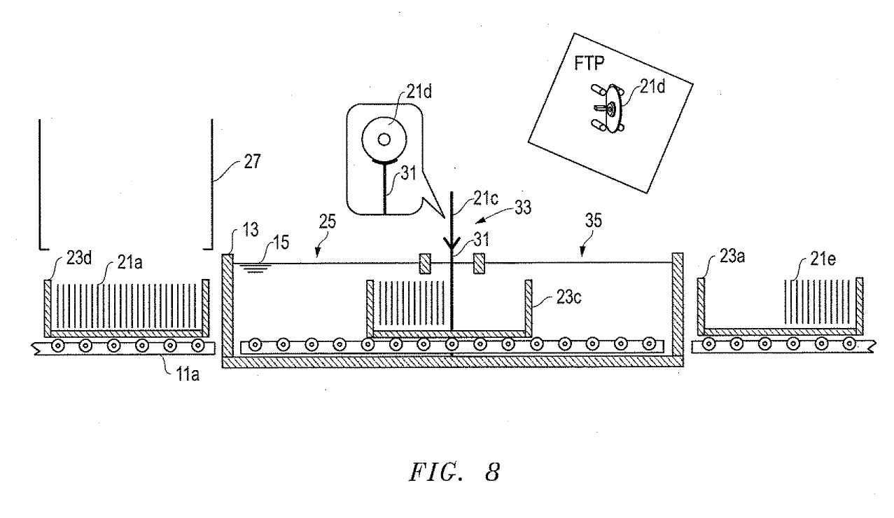

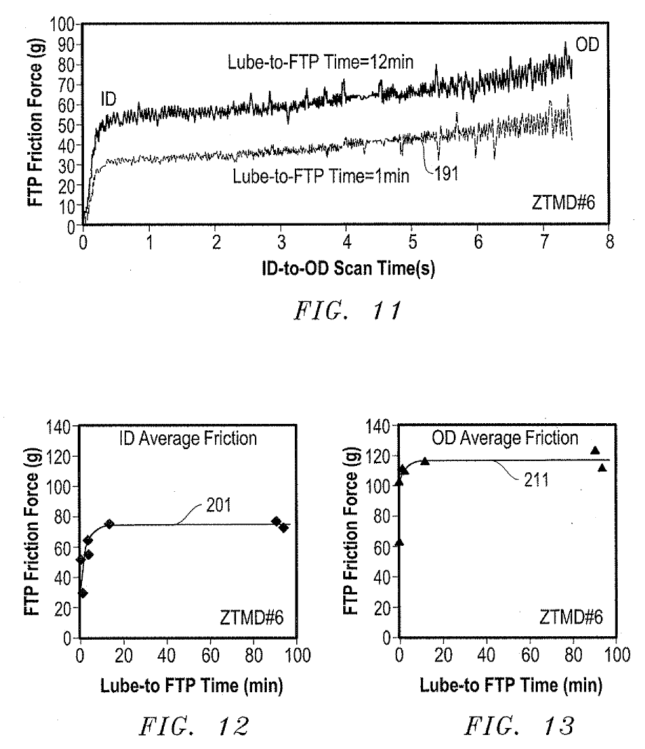

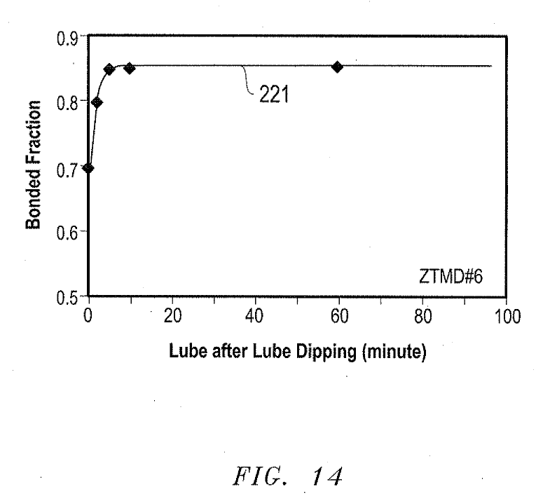

Referring to FIGS. 1-14, embodiments of a system, method and apparatus for combining into a single operation the processes of lubrication and final tape polish (FTP) for magnetic media in hard disk drives applications are disclosed. For example, in one embodiment, the invention comprises a method of processing workpieces or media with a single tool. As shown in FIG. 1, a conveyor 11 is segmented into three portions 11a, 11b and 11c relative to a lubricant bath 13 containing a lubricant solution 15. For example, a concentration of lubricant in the lubricant bath may be provided in a range of 0.04 to 0.08 g/100 mL of solvent.

A plurality of media 21a (e.g., magnetic media disks) are loaded into a first cassette 23a. The cassettes 23 contact and support only the circumferential edges of the media 21. The cassettes 23 have no covers and have openings in their bottoms that provide physical access to the media 21. In operation, the cassette 23a is conveyed on the conveyor 11a toward and adjacent to the upstream end 25 of the lubricant bath 13.

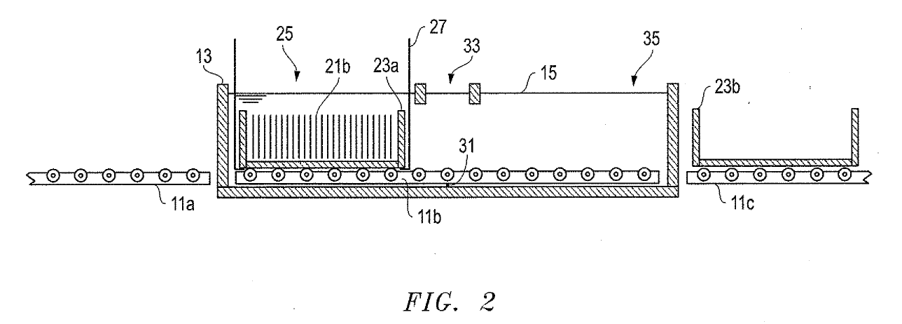

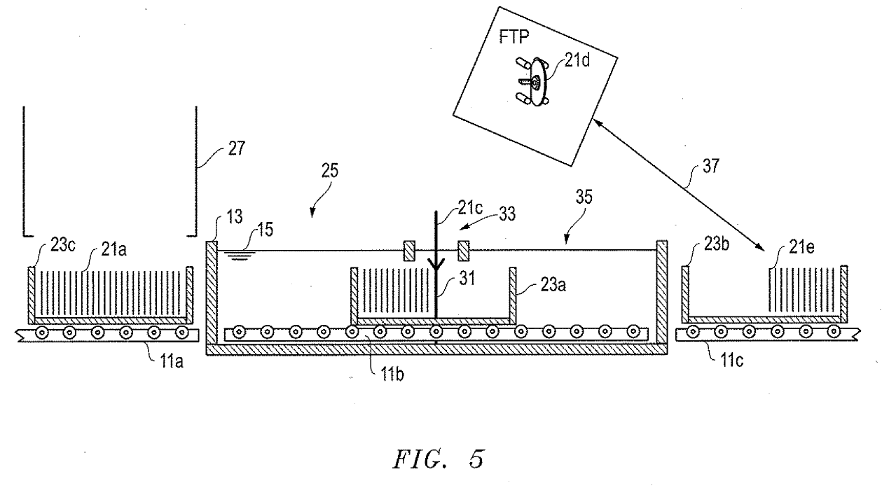

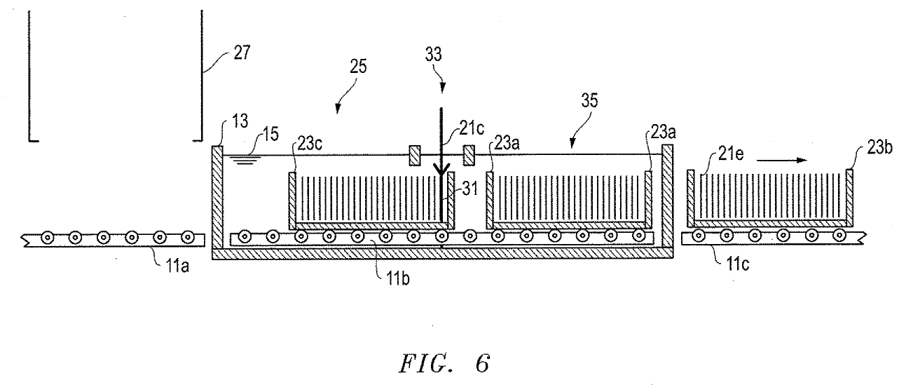

As shown in FIG. 2, the cassette 23 of media 21 is lifted from the conveyor 11a (e.g., with an automated lift 27) and immersed in the lubricant bath 13 on the upstream end 25 (see, e.g., immersed media 21b). The automated lift 27 moves the cassette 23a of media 21 from the conveyor 11a to the lubricant bath 13. The automated lift 27 also may be used to remove the empty cassette 23a (shown in FIG. 6) from the downstream end 35 of the lubricant bath 13 after all of the media 21 is lifted from the cassette in the lubricant bath.

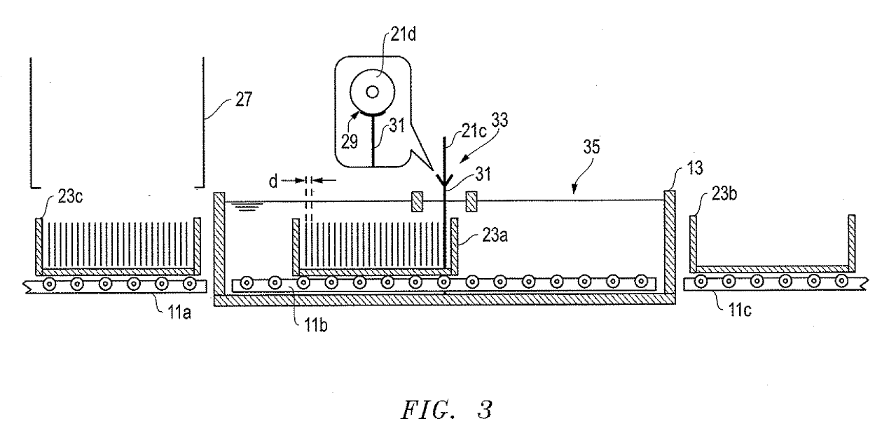

In FIG. 3, the immersed cassette 23a of media 21b is moved along the bath conveyor 11b. For example, this step may comprise incrementally advancing the cassette 23a by a distance approximately equivalent to an axial distance d between the media 21 in the cassette 23a. The media 21 is lifted (see, e.g., lifted media 21c) from below by an arm 31 that extends through the cassette 23a, to coat a lubricant layer on the lifted media (see, e.g., lubricated media 21d). In one embodiment, only one media 21 is lifted at a time to coat the lubricant thereon, and only a circumferential edge 29 of the media 21 is contacted. This step may occur in a central portion 33 of the lubricant bath 13 between the upstream end 25 and a downstream end 35.

In some embodiments, this step comprises lifting the media 21 from the cassette 23 at a speed of approximately 5 mm/s, after “soaking” the media 21 (i.e., before it is lifted out of the lubricant bath 13) for a time of approximately two minutes. In some embodiments, any delay between the steps of lifting the media and FTP may occur in an interval of time of approximately one to two minutes. Thus, the soaking phase is the in-bath time between the immersing and lifting.

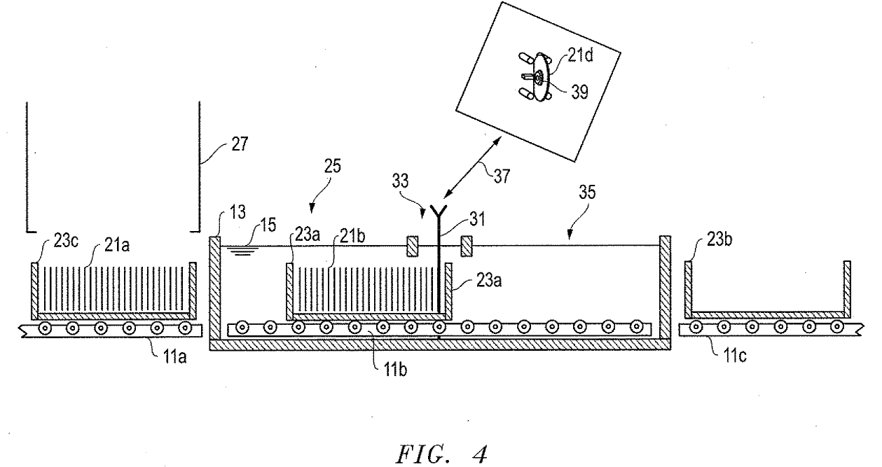

Referring now to FIGS. 4-8, the lubricated media 21d is next final tape polished (FTP). An interval of time of about one second to a few seconds may transpire between the lifting step and FTP. The FTP step may comprise transporting the lubricated media 21 with a robot arm 37 to a FTP spindle 39. The FTP media 21e is then placed into a second cassette 23b (e.g., with robot arm 37) adjacent to and on the downstream end 35 of the lubricant bath 13 on the conveyor 11c. The preceding steps may be repeated until the second cassette 23b is filled with FTP media 21e. Subsequently, the filled second cassette 23b of FTP media 21 is conveyed away from the lubricant bath 13 and the entire process may be repeated.

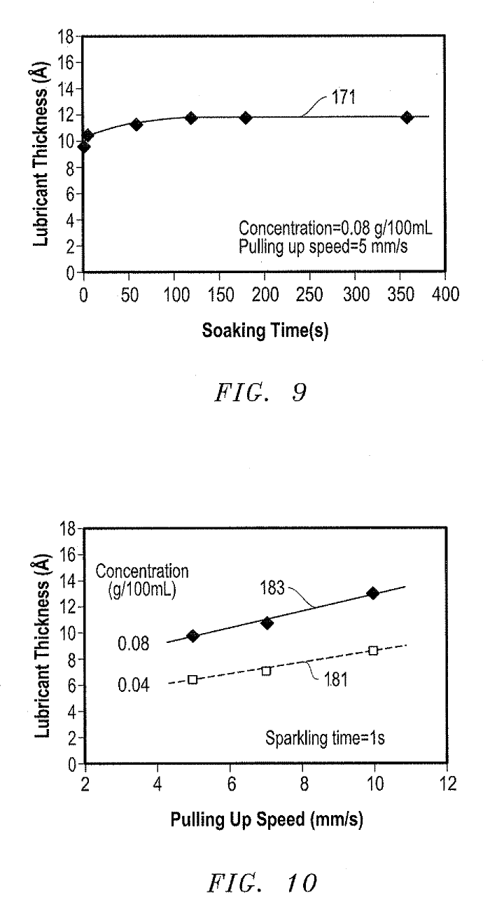

In some embodiments, the shorter in-bath soaking time may affect lube thickness. For example, experiments with Z-Tetraol 2290 (see, e.g., FIG. 9) demonstrate that soaking the media does not affect lube thickness 171 beyond about two minutes. Longer soaking time does not affect final lube thickness as shown in FIG. 9. Otherwise, lube thickness would be different for each disk due to different soaking time. In order not to affect throughput, immersion can start as soon as the prior cassette is out of the way. To facilitate this, the upstream portion of the bath is sufficiently wide to accommodate multiple cassettes that are spaced apart from each other. With a throughput of about 120 disks per hour, immersion may start with at least four disks left in the prior cassette. Thus, soaking the media in the bath for two minutes or longer is workable for a throughput of 120 to 150 disks per hour. FIG. 10 shows that lubricant thickness can be varied and controlled using in-bath concentrations 181, 183 and/or pulling-up speed.

The plots 191, 201, and 211 in FIGS. 11-13, respectively, illustrate that FTP friction is reduced by almost 50% by shortening the lube-to-FTP delay to no more than one minute for, e.g., fractions of ZTMD lubricant. Plot 221 of FIG. 14 shows that the effect is consistent with the fast-bonding kinetics for the same lubricant.

The invention has numerous advantages over prior art techniques, which include shortening the delay time between the lubrication and FTP processes. As a result, there is more free lubricant, lower burnish friction, and a higher glide yield. The invention also reduces the floor space required for current lubrication equipment, giving room for expansion without having to build larger clean rooms. In addition, the invention offers these advantages without loss of throughput, lubricant uniformity, or media quality compared to conventional techniques. In some embodiments, the improvements described herein still require set-ups for solvent-vapor collection over the bath and vibration isolation beneath the bath.

While the invention has been shown or described in only some of its forms, it should be apparent to those skilled in the art that it is not so limited, but is susceptible to various changes without departing from the scope of the invention.

We claim:

1. A method of processing media, comprising:
(a) loading a plurality of the media into a cassette and conveying the cassette of media on a conveyor toward and adjacent to an upstream end of a lubricant bath;
(b) lifting the cassette of media from the conveyor and immersing it in the lubricant bath;
(c) moving the immersed cassette of media along a bath conveyor;
(d) lifting a media from the cassette of media to coat a lubricant layer on the lifted media;
(e) final tape polishing (FTP) the lubricated media;
(f) placing the FTP media into a second cassette adjacent to and on a downstream end of the lubricant bath on the conveyor;
(g) repeating steps (c) through (f) and filling the second cassette with FTP media; and then
(h) conveying the filled second cassette of FTP media away from the lubricant bath.

2. A method according to claim 1, wherein step (b) comprises using an automated lift to move the cassette of media from the conveyor to the lubricant bath, and further comprising using the automated lift to remove an empty cassette from the lubricant bath after all of the media is lifted from the cassette in the lubricant bath.

3. A method according to claim 1, wherein step (c) comprises incrementally advancing the cassette by a distance approximately equivalent to an axial distance between the media in the cassette.

4. A method according to claim 1, wherein step (d) comprises lifting only one media at a time to form the lubricant thereon, and only contacting a circumferential edge of the media.

5. A method according to claim 1, wherein step (e) comprises transporting the lubricated media with a robot arm to a FTP spindle, and step (f) comprises transporting the FTP media with the robot arm to the second cassette.

6. A method according to claim 1, wherein, between steps (d) and (e) an interval of time of a few seconds transpires.

7. A method according to claim 1, wherein, between steps (d) and (e) an interval of time of approximately one second transpires.

8. A method according to claim 1, wherein step (b) occurs in the upstream end, empty cassettes are removed from the downstream end, and step (d) occurs in a central portion of the lubricant bath between the upstream and downstream ends.

9. A method according to claim 1, wherein a concentration of lubricant in the lubricant bath is in a range of 0.04 to 0.08 g/100 mL, and step (d) comprises soaking the media for a time of approximately two minutes, and lifting the media at a speed of approximately 5 mm/s.

10. A method of processing media, comprising:
(a) loading a plurality of the media into a cassette and conveying the cassette of media on a conveyor toward and adjacent to an upstream end of a lubricant bath;
(b) lifting the cassette of media from the conveyor and immersing it in the lubricant bath in the upstream end of the lubricant bath, the cassette being moved by an automated lift;
(c) moving the immersed cassette of media along a bath conveyor;
(d) lifting a media from the cassette of media to coat a lubricant layer on the lifted media, the media being lifted from a central portion of the lubricant bath between the upstream and downstream ends;
(e) final tape polishing (FTP) the lubricated media;
(f) placing the FTP media into a second cassette adjacent to and on a downstream end of the lubricant bath on the conveyor;
(g) repeating steps (c) through (f), filling the second cassette with FTP media, and removing an empty cassette from the downstream end with the automated lift after all of the media is lifted from the cassette in the lubricant bath; and then
(h) conveying the filled second cassette of FTP media away from the lubricant bath.

11. A method according to claim 10, wherein step (c) comprises incrementally advancing the cassette by a distance approximately equivalent to an axial distance between the media in the cassette.

12. A method according to claim 10, wherein step (d) comprises lifting only one media at a time to form the lubricant thereon, and only contacting a circumferential edge of the media.

13. A method according to claim 10, wherein step (e) comprises transporting the lubricated media with a robot arm to a FTP spindle, and step (f) comprises transporting the FTP media with the robot arm to the second cassette.

14. A method according to claim 10, wherein, between steps (d) and (e) an interval of time of approximately one second to a few seconds transpires.

15. A method according to Claim I0, wherein a concentration of lubricant in the lubricant bath is in a range of 0.04 to 0.08 g/100 mL, and step (d) comprises soaking the media for a time of approximately two minutes, and lifting the media at a speed of approximately 5 mm/s.

16. A method of processing media, comprising:
(a) loading a plurality of the media into a cassette and conveying the cassette of media on a conveyor toward and adjacent to an upstream end of a lubricant bath;
(b) lifting the cassette of media from the conveyor and immersing it in the lubricant bath in the upstream end of the lubricant bath, the cassette being moved by an automated lift;
(c) moving the immersed cassette of media along a bath conveyor by incrementally advancing the cassette by a distance approximately equivalent to an axial distance between the media in the cassette;
(d) lifting a media from the cassette of media to coat a lubricant layer on the lifted media, the media being lifted from a central portion of the lubricant bath between the upstream and downstream ends, wherein only one media at a time is lifted at a time to form the lubricant thereon, and only contacting a circumferential edge of the media;
(e) transporting the lubricated media with a robot arm to a final tape polishing (FTP) spindle, and FTP the lubricated media;
(f) placing the FTP media into a second cassette adjacent to and on a downstream end of the lubricant bath on the conveyor, the FTP media being transported by the robot arm;
(g) repeating steps (c) through (f), filling the second cassette with FTP media, and removing an empty cassette from the downstream end with the automated lift after all of the media is lifted from the cassette in the lubricant bath; and then
(h) conveying the filled second cassette of FTP media away from the lubricant bath.

17. A method according to claim 16, wherein, between steps (d) and (e) an interval of time of approximately one second to a few seconds transpires.

18. A method according to claim 16, wherein a concentration of lubricant in the lubricant bath is in a range of 0.04 to 0.08 g/100 mL, and step (d) comprises soaking the media for a time of approximately two minutes, and lifting the media at a speed of approximately 5 mm/s.
